(19) United States
(12) Patent Application Publication
(10) Pub. No.: US 2006/0223579 A1
(43) Pub. Date: Oct. 5, 2006

(54) Universal battery charger and data transfer system

(76) Inventors: Parrish Whitaker, Toluca Lake, CA (US); Anderson Crosby, Toluca Lake, CA (US)

Correspondence Address: KEVIN J. MCNEELY, ESQ., 5335 WISCONSON AVENUE, NW, SUITE 440, WASHINGTON, DC, 20015, US

(21) Appl. No.: 11/097,291

(22) Filed: Apr. 4, 2005

(51) Int. Cl. H04B 1/38; H04M 1/00

(52) U.S. Cl. 455/557; 455/573

(57) ABSTRACT

A universal battery charger and data transfer system includes a data transfer module and a power supply module. The data transfer module has a data protocol detection circuit that detects the data transfer protocol of the wireless communication device. The data transfer module also has a programmable data transfer circuit that transfer data according to the data transfer protocol.

### TECHNICAL FIELD

The invention relates to a battery charger and data transfer system and, more particularly to a battery charger and data transfer system that can be used with a variety of wireless communication devices, such as, for example, mobile telephones or PDAs (PDAs).

### BACKGROUND

Consumers typically purchase a mobile phone or other type of wireless communication device every few years. Each mobile phone or wireless communication device typically comes with a battery charger to be used with that particular mobile phone model. Thus, the consumer usually ends of with many different battery chargers that cannot be used. In addition, the consumer may have stored data on the older mobile phone that he desires to transfer to the newer wireless communication device. Thus, a need exists for a universal system that can be used for battery charging and data transfer.

### SUMMARY

In one general aspect, a universal battery charger and data transfer system includes a data transfer module and a power supply module. The data transfer module has a data protocol detection circuit that detects the data transfer protocol of the wireless communication device. The data transfer module also has a programmable data transfer circuit that transfer data according to the data transfer protocol.

The power supply module includes a power detection circuit that detects the power input requirement of the wireless communication device. A power supply circuit supplies power to the wireless communication device according to the power input requirement.

Features may include one or more of the following. For example, the system may include a storage module that can store and/or backup data transferred from the mobile communication device. The system may also include a data jack configured to receive more than one type of data connector, with each type of data connector having a unique property that is detectable by the data protocol detection circuit.

In addition, the system may include a power jack configured to receive more than one type of power connector, with each type of power jack having a unique property that is detectable by the power detection circuits to determine the power input requirement.

The system may include first, second and third connector cords having respective universal serial bus connectors, data connectors and types of power connectors.

In another general aspect, a universal mobile phone data transfer and battery charger system includes a variable power system module and a programmable data transfer module. The variable power system module operable is operable to charge first, second, and third mobile phones having a first, second, and third charging requirements, respectively. The programmable data transfer module is operable to transfer data between a PC and the first, second, and third mobile phones having first, second, and third data transfer protocols, respectively.

The system includes first, second, and third connector cords that are compatible with the first, second, and third mobile phones. Each of the cords includes a logic circuit identifying the power and data transfer requirements of the particular mobile phone type.

The system may include one or more of the following or above features. For example, each connector cord may have a universal serial bus connector at one end. A memory card may be used to store data transferred from one of the mobile phones. The system may have a controller operable to receive the identifying information and modify the operating characteristics of the power supply module and the data transfer module according to the identifying information.

In another general aspect, a method of recharging and backing up data of more than one mobile phone type includes identifying a charging requirement and data transfer protocol of the mobile phone type, recharging a mobile phone according to the charging requirement of the mobile phone type, and transferring data from the mobile phone according to the data transfer protocol of the mobile phone type.

The system and method may be implemented by hardware, software, or a combination thereof.

### DESCRIPTION OF THE DRAWINGS

FIG. 1 shows an overview diagram of the universal system.

FIG. 2 shows a block diagram of the universal system.

FIG. 3 shows a block diagram of a power supply charger for the universal system.

FIG. 4 shows a block diagram of a data transfer system for the universal system.

FIG. 5 shows a flowchart of a power charging and data transfer method.

FIG. 6 shows a block diagram of the universal system used with multiple electronic devices.

### DETAILED DESCRIPTION

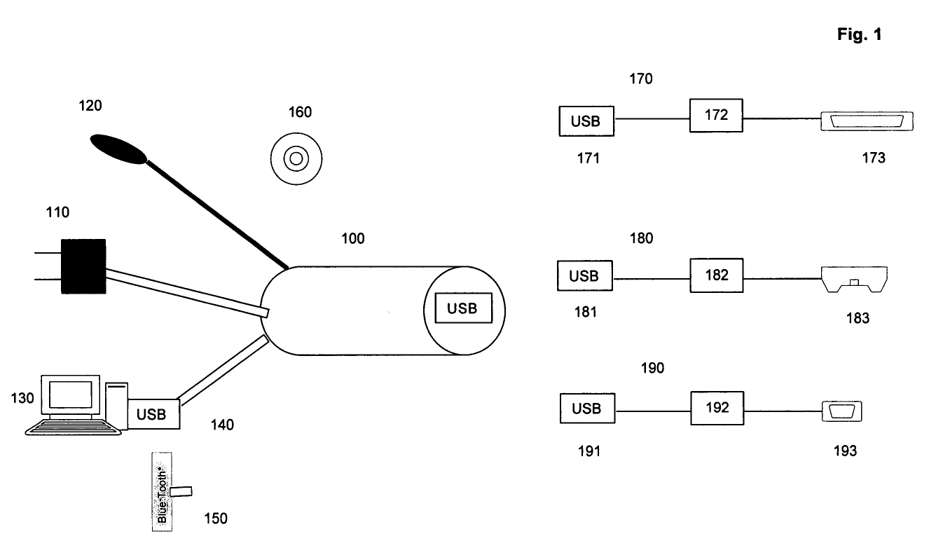

Referring to FIG. 1, a universal battery charger and data transfer system 100 can be used to backup data and charge the batteries of a wireless communication device, such as, for example, a mobile telephone, a mobile telephone, a wireless pager, or a PDA with wireless functionality. The system 100 has a dual input for use in a house with a 120-volt A.C. input jack 110 and in a mobile environment with a 12-volt D.C. input jack 120.

The system 100 interfaces with a personal computer (PC) 130 with a universal serial bus (USB) connector 140 or through a blue tooth wireless connection 150. A compact disk 160 is provided to install a software program on the PC 130.

The system may be used with a variety of mobile telephone brands and models, PDAs, and other types of wireless digital devices that may include digital cameras, MP3 devices, etc. Thus, the system 100 includes connector cords 170, 180, 190, each having an interface circuit 172, 182, 192 and a particular connector 173, 183, 193 for the particular communication device.

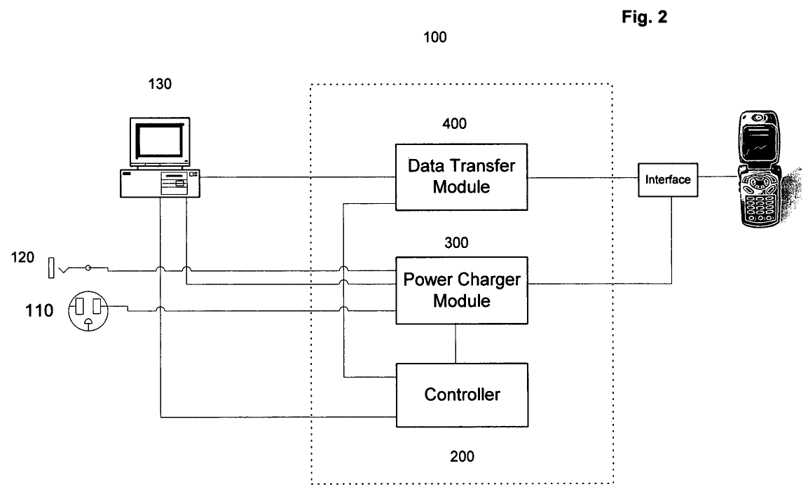

Referring to FIG. 2, the system 100 includes a power supply module 300 and a data transfer module 400. A controller 200 is used to vary the power output of the power supply module 300 and to control data transfer by the data transfer module 400.

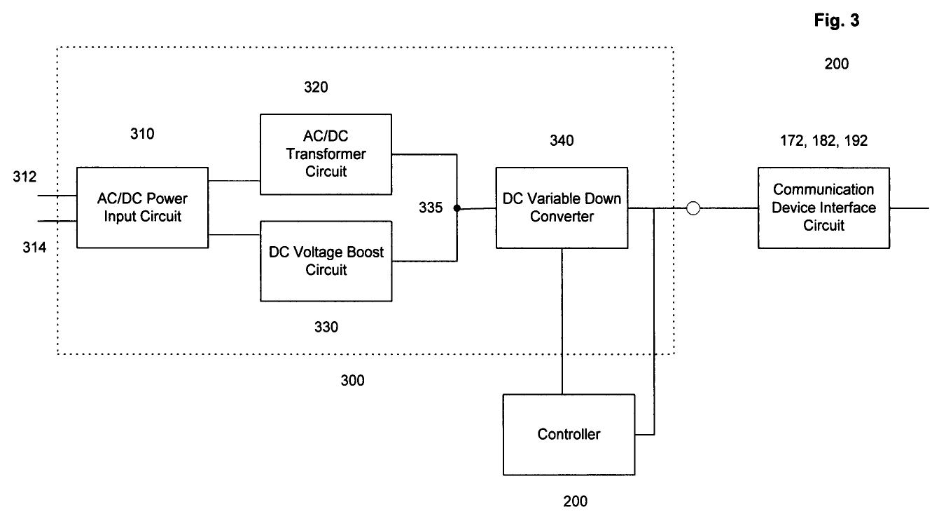

Referring to FIG. 3, the power supply module 300 includes an AC/DC input circuit 310, which allows the system 100 to accept either 120 volt AC or 12 volt DC from AC or DC input terminals 312 and 314, respectively. When the input is from the AC terminal 312, the AC/DC converter circuit 320 is utilized to produce a 30-volt DC output. In one embodiment (not shown), the AC/DC converter circuit 320 includes a linear power circuit with a step down transformer, a rectifier, and an AC ripple filter. In another embodiment, the AC/DC converter circuit includes a switch mode power supply.

When the input is form the DC terminal 314, the DC voltage boost circuit is utilized to boost the voltage from 12 volts DC to 30 volts DC. Thus, the power available at the common node 335 is always 30 volts DC.

The DC variable down converter 340 provides a DC output in the range of 3 volts to 30 volts, which gives the system a wide operating range for compatibility with a variety of mobile phone battery systems. The actual output of the DC variable down converter 340 is established according to instructions from the controller 200.

The configuration instructions from the controller 200 may be established using a variety of methods. As one example, the user inputs the type of mobile telephone that will be interfaced with the system 100 during a setup routine. In another example, each of the connector cords 170, 180, 190 has a unique resistive value that corresponds to a specific voltage setting. Note that the number of connector cords 170, 180, 190 may vary based on the number of mobile telephone model connector configurations. In another embodiment, the communication device interface circuits 172, 182, 192 in each connector cord 170, 180, 190 store operating data about the particular power and data requirements of the wireless communications device. Thus, when a cord 170, 180, 190 is connected to the USB port of the universal system 100, the operating data is forwarded to the controller 200, which then provides the appropriate operating instruction to the DC variable down converter 340.

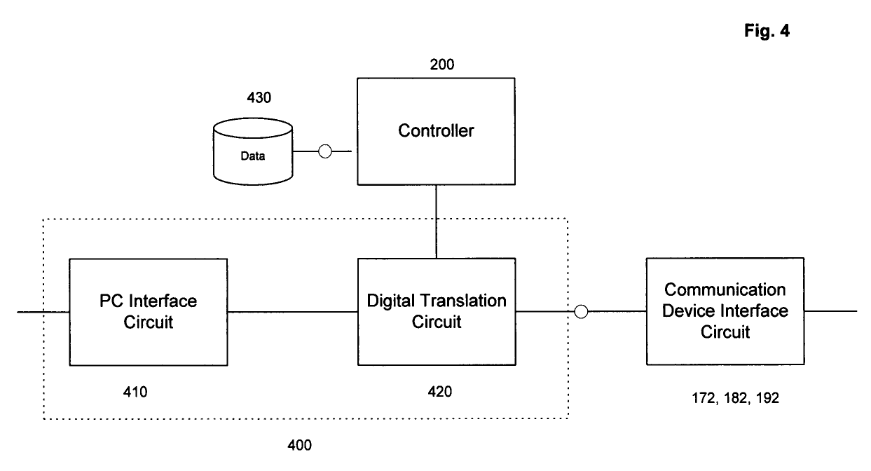

Referring to FIG. 4, the data transfer module 400 includes a PC interface circuit 410 and a digital translation circuit 420. The PC interface circuit 410 includes a USB serial interface engine which serializes communications to the PC according to standard USB protocols. The digital translation circuit 420 performs synchronous and asynchronous functions according to instructions provided by the controller 200 for compatibility with the mobile phone or wireless communication device data channel.

If the data transfer module 400 is not connected to a PC (not shown), the controller instructs the data transfer module 400 to store information in a memory module 430. The memory module 430 may be removable so that is can be stored or inserted into another electronic device. For example, the memory module may be a memory card or flash memory with a USB port.

The communication device interface circuits 172, 182, 192, which are imbedded in the connector cords 170, 180, 190, are used to provide electrical connections to the signals on the wireless communication device. The configuration of each communication device interface circuit 172, 182, 192 is in accordance with the particular mobile telephone used to connect to the universal system 100. The communication device interface circuit 172, 182, 192 also provides operating data to the controller 200 which provides protocol instructions to the digital translation circuit 420.

In operation, the user inserts the CD 160 into the disk drive of the PC 130 to download a driver program. The user plugs a particular wireless device connector cord 170, 180, 190 into the universal system USB port and connects the USB cord 140 from the universal system 100 into a USB port of the PC 130. The wireless device connector 173, 183, 193 is plugged into the wireless communication device and the universal system 100 is powered up by either 12 volts DC or 120 volts AC.

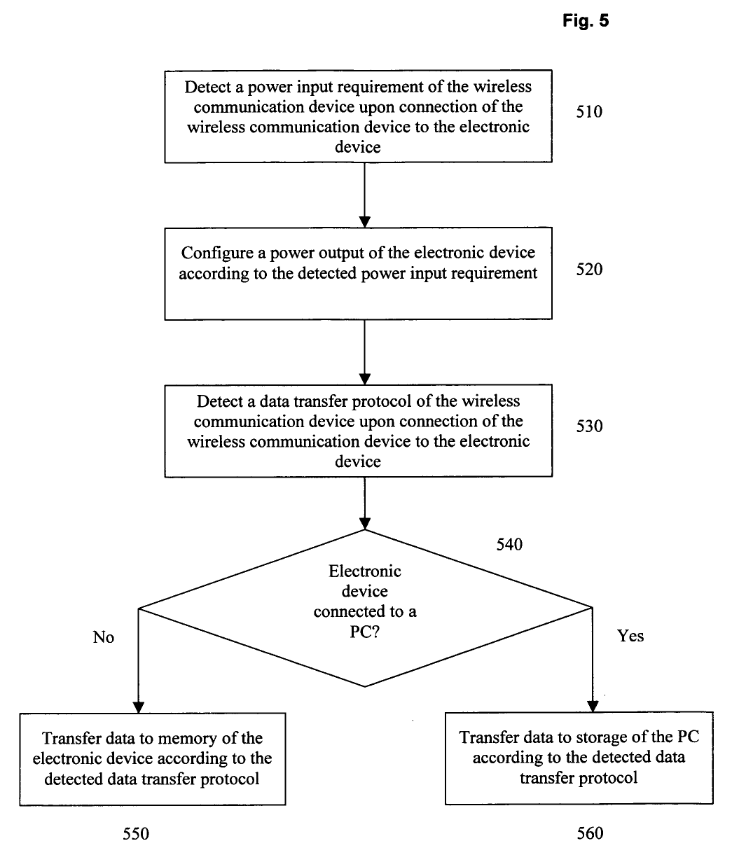

A program menu is called up on the PC 130 prompting the user to initiate a backup. Referring to FIG. 5, the program detects the input power requirement of the wireless communication device upon connection of the wireless communication device to the USB port of the universal system (referred to in FIG. 5 as the “electronic device”) in operation 510. The power output of the electronic device is then configured according to the input power requirement in operation 520.

The program also detects the data transfer protocol of the wireless communication device upon connection with the electronic device in operation 530. The program determines whether the USB cord of the electronic device is connected to a PC in operation 540. If the electronic device is connected to a PC, the data is transferred to storage on the PC according to the data transfer protocol in operation 550. If the electronic device is not connected to the PC, the data is transferred to a memory of the electronic device in operation 560.

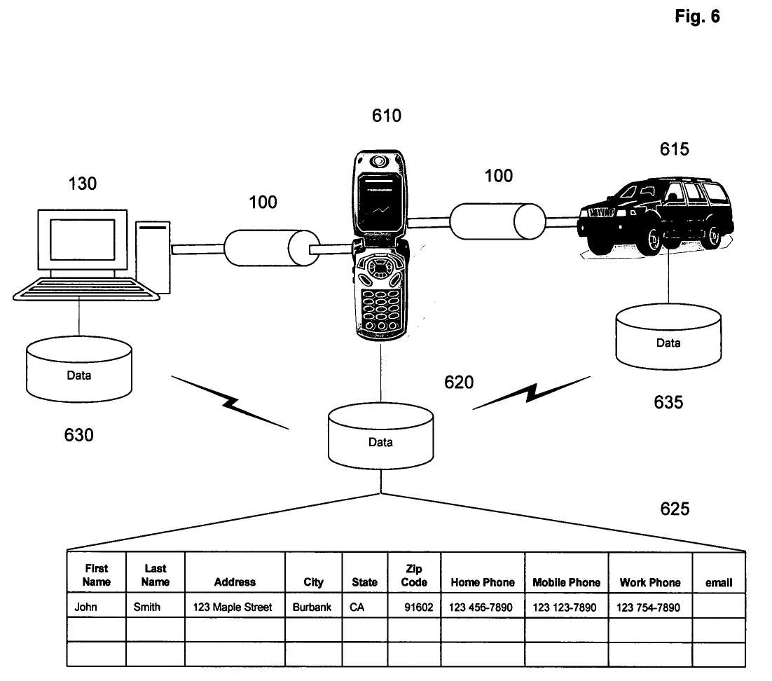

Referring to FIG. 6, the universal system 100 can be used to transfer data between a personal computer 130, a mobile phone 610, and a computer in a mobile vehicle, such as, for example, a vehicle navigation system 615. The data is stored in a database 620 in a common database format 625. Thus, the personal computer 130 and the vehicle navigation system 615 can store the data in their respective memory or storage multiple electronic devices can use and store the data in their own internal memories.

In one embodiment, the universal system is equipped with wireless communication functionality. The data may be wirelessly transferred to a database for utilization by another wireless device upon a single command by a user. For example, the stored data may be uploaded to a global positioning system device which utilizes physical address information of a personal contact to determine driving instructions.

The system and method described above can be implemented by hardware, software, or a combination thereof.

The present invention has been particularly described with reference to particular features. However, those of ordinary skill in the art will recognize that modifications in form and details may be made without departing from the spirit and scope of the invention.

We claim:

1. A universal data transfer and battery charger system, comprising:
a data transfer module that detects a data transfer protocol of a wireless communication device and transfers data according to the data transfer protocol of the wireless communication device; and
a power supply module that detects a power input requirement of the wireless communication device and supplies power to the wireless communication device according to the power input requirement.

2. The system of claim 1, further comprising:
a wireless communication module detecting the wireless communication device within a physically proximate distance;
wherein the data transfer module wirelessly transmits the data according to the data transfer protocol in response to a single command by a user.

3. The system of claim 1, further comprising:
a storage device storing data transferred from the wireless communication device.

4. The system of claim 1, further comprising:
a data jack configured to receive more than one type of data connector;
wherein the data protocol detection circuit detects the type of data connector to determine the data transfer protocol.

5. The system of claim 1, further comprising:
a power jack configured to receive more than one type of power connector; and
wherein the power detection circuits detect the type of power connector to determine the power input requirement.

6. The system of claim 1, further comprising:
a first connector cord having a first universal serial bus connector, a first type of data connector and a first type of power connector;
a second connector cord having a second universal serial bus connector, a second type of data connector and a second type of power connector; and
a third connector cord having a third universal serial bus connector, a third type of data connector and a third type of power connector.

7. A universal data transfer and battery charger system, comprising:
a variable power system module operable to charge a first wireless communication device having a first charging requirement, a second wireless communication device having a second charging requirement, and a third wireless communication device having a third charging requirement;
a programmable data transfer module operable to transfer data between a PC and the first wireless communication device having a first data transfer protocol, the second wireless communication device having a second data transfer protocol, and the third wireless communication device having a third data transfer protocol;
a first connector cord connecting the PC to the first wireless communication device, the first connector cord having a first imbedded logic circuit identifying the power and data transfer requirements of the first wireless communication device;
a second connector cord connecting the PC to the second wireless communication device, the second connector cord having a second imbedded logic circuit identifying the power and data transfer requirements of the second wireless communication device; and
a third connector cord connecting the PC to the third wireless communication device, the third connector cord having a third imbedded logic circuit identifying the power and data transfer requirements of the third wireless communication device.

8. The system of claim 7, further comprising:
a universal serial bus connector at a first end of each of the first, second, and third connector cords.

9. The system of claim 7, further comprising:
a memory configured to store data transferred from one of the first, second, and third wireless communication device.

10. The system of claim 7, further comprising:
a controller operable to receive the identifying information and modify the operating characteristics of the power supply module and the data transfer module according to the identifying information.

11. The system of claim 7, wherein the wireless communication device comprises a mobile telephone.

12. The system of claim 7, wherein the wireless communication device comprises a mobile telephone.

13. The system of claim 7, wherein the wireless communication device comprises a personal digital assistant.

14. A method of recharging and backing up data of more than one wireless communication device type, the method comprising:
identifying a charging requirement and data transfer protocol of the wireless communication device type;
recharging a wireless communication device according to the charging requirement of the wireless communication device type;
transferring data from the wireless communication device according to the data transfer protocol of the wireless communication device type.

15. The method of claim 14, wherein the transferring comprises transferring data from the wireless communication device to a personal computer according to the data transfer protocol of the wireless communication device type.

16. The method of claim 14, further comprising:
storing the transferred data in a memory of a device configured to recharge and transfer the data from the wireless communication device.

17. The method of claim 14, further comprising:
storing the data in a database, wherein the data includes a physical address of personal contact;
uploading the physical address information to a global positioning system; and
determining driving directions from a current position to the physical address.

18. A computer readable medium having embodied thereon a computer program for processing by a computer to instruct an electronic device to recharge a wireless communication device and to transfer data from the wireless communication device, the computer program comprising:
a first code segment to detect a power input requirement of the wireless communication device upon connection of the wireless communication device to the electronic device;
a second code segment to configure a power output of the electronic device according to the detected power input requirement;
a third code segment to detect a data transfer protocol of the wireless communication device upon connection of the wireless communication device to the electronic device;
a fourth code segment to determine if the electronic device is connected to an external computer; and
a fifth code segment to transfer data from the wireless communication device to a memory of the electronic device according to the detected data transfer protocol if the electronic device is not connected to the external computer or to transfer data from the wireless communication device to storage of the external computer according to the detected data transfer protocol if the electronic device is connected to the external computer.

19. The computer program of claim 18, wherein the fourth code segment determines whether the electronic device is connected to the external computer by a wireless connection.

20. The computer program of claim 18, further comprising:
a sixth code segment storing the transferred data in a common database format in the storage of the external computer.
